(19) United States
(12) Patent Application Publication
(10) Pub. No.: US 2026/0180855 A1
(43) Pub. Date: Jun. 25, 2026

(54) METHOD AND SYSTEM FOR MANAGING OVER-THE-AIR UPGRADE IN EDGE DEVICES

(71) Applicant: NETRADYNE, INC., San Diego, CA (US)

(72) Inventors: Ankit Srivastava, Bengaluru (IN); Vishal Gupta, Bengaluru (IN); Syam Krishna Malla, Bengaluru (IN); Ravi Vaidya, Gaya (IN)

(73) Assignee: NETRADYNE, INC., San Diego, CA (US)

(21) Appl. No.: 19/425,412

(22) Filed: Dec. 18, 2025

(30) Foreign Application Priority Data
Dec. 20, 2024 (IN) 202411101439

(51) Int. Cl. H04L 41/082; G06F 8/65; H04L 41/0816

(52) U.S. Cl. CPC H04L 41/082; G06F 8/65; H04L 41/0816

(57) ABSTRACT

A method for managing an upgrade rollout to a plurality of edge devices comprises identifying a first set of edge devices based on a communication history indicating successful communication frequency between each edge device and the cloud server. The method includes pushing the upgrade to the first set of edge devices and receiving feedback from the first set of edge devices, wherein the feedback includes information related to operational metrics of at least one of software and hardware components. The method ensures safety-critical monitoring functions remain operational throughout the deployment process by determining a fault percentage representing edge devices from the first set wherein the operational metrics deviate from baseline performance values beyond predetermined tolerance thresholds. After a predefined time duration from completion of pushing the upgrade, the method automatically determines whether to continue with the upgrade rollout to remaining edge devices of the plurality of edge devices.

### CROSS-REFERENCE TO RELATED APPLICATIONS

This application claims the benefit of priority to IN Provisional Patent Application No. 202411101439, filed Dec. 20, 2024, the entirety of which is incorporated by reference herein.

### TECHNICAL FIELD

The present disclosure relates to upgrading devices, more particularly to a method and system for managing an over-the-air upgrade in edge devices installed in vehicles.

### BACKGROUND

The information in this section merely provides background information related to the present disclosure and may not constitute prior art(s) for the present disclosure.

Edge computing devices deployed in vehicular environments perform critical monitoring and data processing functions. These devices collect and analyze operational data, monitor vehicle performance parameters, and capture driver behavior information to enhance safety and operational efficiency. Such edge devices operate continuously in mobile environments characterized by varying environmental conditions, network connectivity fluctuations, and diverse operational demands.

Vehicle-mounted edge devices require periodic software updates to maintain monitoring accuracy, incorporate algorithm enhancements, adapt detection parameters, and ensure compatibility with evolving fleet management infrastructures. The distributed nature of vehicular edge device deployments, spanning multiple vehicles across diverse geographic regions, necessitates remote software distribution capabilities that can reach devices without requiring vehicle downtime or service interruption.

The deployment of software updates to edge devices operating within vehicle fleets presents distinct technical challenges. Vehicles operate across varying network coverage areas, experience intermittent connectivity based on geographic location and operational patterns, and may have limited windows for receiving updates based on vehicle duty cycles. Additionally, the critical nature of driver monitoring and safety-related functions performed by these devices require that software updates not compromise ongoing monitoring capabilities or data collection integrity.

Fleet-wide software deployments introduce risks of systematic failures that could affect multiple vehicles simultaneously. The heterogeneous nature of vehicle fleets, comprising different vehicle types, varying hardware configurations, and diverse operational profiles, creates uncertainty in predicting update outcomes across the entire device population. Performance variations or failures induced by software updates may impact driver monitoring capabilities, potentially affecting fleet safety metrics and regulatory compliance requirements.

Therefore, there is a need for an improved method and system for managing software deployments to edge devices that ensure controlled distribution while maintaining continuous monitoring capabilities and minimizing risks to fleet-wide operations.

The drawbacks/difficulties/disadvantages/limitations of the conventional techniques explained in the background section are just for exemplary purposes and the disclosure would never limit its scope only such limitations. A person skilled in the art would understand that this disclosure and below mentioned description may also solve other problems or overcome the other drawbacks/disadvantages.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an aspect of the present disclosure, a method for managing an upgrade rollout to a plurality of edge devices is disclosed. The method includes identifying, by at least one processor of a cloud server, a first set of edge devices among the plurality of edge devices for an upgrade rollout, wherein the identifying is based on a communication history indicating successful communication frequency between each edge device and the cloud server. The method further comprises pushing the upgrade to the first set of edge devices, receiving feedback from the first set of edge devices wherein the feedback comprises information related to operational metrics of at least one of software and hardware components of the first set of edge devices, determining a fault percentage representing edge devices from the first set wherein the operational metrics deviate from baseline performance values beyond predetermined tolerance thresholds, and determining, after a predefined time duration (Td) from completion of pushing the upgrade, whether to continue with the upgrade rollout to remaining edge devices of the plurality of edge devices.

In an embodiment, the communication history comprises at least one of: a frequency of heartbeat signals transmitted from each edge device to the cloud server; a success rate of data transmissions between each edge device and the cloud server; a temporal recency of last successful communication with the cloud server; and a signal strength metric associated with network connectivity. The identifying of the first set of edge devices may further comprise determining a working status of hardware and software components for each edge device based on the heartbeat signals, wherein edge devices are selected for the first set when the working status indicates an operating condition without detected irregularities.

The operational metrics comprise at least one of: processor utilization percentage; memory consumption values; battery discharge rate; component uptime duration; data throughput measurements; and error frequency indicators. The baseline performance values are generated by monitoring the operational metrics during a pre-upgrade period, calculating average performance values for each metric, and storing said average performance values as reference baselines for post-upgrade comparison. The predetermined tolerance thresholds comprise expected performance variations inherent to the upgrade process and acceptable deviation ranges determined through pre-deployment testing, wherein an edge device is classified as faulty when operational metric deviation exceeds the sum of expected degradation and acceptable deviation range.

In response to determining to continue with the upgrade rollout, the method further comprises determining a deployment multiplier (M) based on the fault percentage and identifying a second set of edge devices from the remaining edge devices, wherein a size of the second set equals the product of the deployment multiplier and a size of the first set. The determining of the deployment multiplier comprises assigning a first multiplier value when the fault percentage is below a first threshold, indicating that operational metrics confirm stable upgrade performance across the first set of devices, justifying accelerated deployment, assigning a second multiplier value when the fault percentage is between the first threshold and a second threshold indicating maintained deployment pace, wherein the first multiplier value exceeds the second multiplier value.

As used herein, ‘fault percentage’ refers to the percentage of edge devices exhibiting operational metric deviations beyond predetermined statistical thresholds, which may include devices operating normally but outside predicted ranges due to environmental factors, network conditions, or vehicle usage patterns. The fault percentage is a conservative detection metric designed to identify potential issues early, and does not represent actual device failures or safety compromises. Devices classified as ‘faulty’ undergo additional analysis to distinguish between benign metric variations and genuine operational issues requiring intervention.

The method further comprises iteratively repeating the identifying, pushing, receiving, and determining steps for subsequent sets of edge devices, wherein a cumulative number of edge devices receiving the upgrade in iteration i follows an arithmetic progression defined by: Ni=K+(i−1)(M×K), where K represents the size of the first set, and M represents the deployment multiplier determined for each iteration. The method includes dynamically modifying rollout parameters during deployment execution, wherein the modification comprises adjusting at least one of: the deployment multiplier between iterations based on emerging performance patterns; the predefined time duration based on feedback collection rate; and selection criteria for subsequent device sets based on accumulated deployment data.

The method includes maintaining a deployment log tracking upgrade status for each edge device, generating a rollout trajectory prediction based on current fault percentage trends, and dynamically adjusting the deployment multiplier based on the rollout trajectory prediction. In response to determining not to continue with the upgrade rollout, the method comprises terminating further upgrade deployment to the remaining edge devices and initiating a rollback procedure for the first set of edge devices to restore a previous firmware version. The determination not to continue occurs when the fault percentage exceeds a critical threshold value or when a predetermined number of consecutive edge devices report critical component failures.

The predefined time duration (Td) is determined based on at least one of: geographic distribution of the plurality of edge devices; expected vehicle operational cycles associated with the edge devices; network traffic patterns for the communication infrastructure; and statistical confidence intervals for feedback data collection. The receiving of feedback comprises collecting periodic status reports from each edge device in the first set, aggregating operational metrics across multiple reporting cycles, and identifying performance anomalies through statistical deviation analysis.

In an embodiment, the plurality of edge devices comprises multiple device models identified by distinct stock keeping units (SKUs), wherein the method further comprises segregating the upgrade rollout by SKU categories and maintaining separate fault percentage thresholds for each SKU based on device-specific performance characteristics.

According to another aspect of the present disclosure, a system for managing an upgrade rollout to a plurality of edge devices is disclosed. The system comprises a memory and at least one processor in communication with the memory. The at least one processor is configured to identify a first set of edge devices among the plurality of edge devices for an upgrade rollout based on a communication history indicating successful communication frequency between each edge device and a cloud server; push the upgrade to the first set of edge devices; receive feedback from the first set of edge devices, wherein the feedback comprises information related to operational metrics of at least one of software and hardware components; determine a fault percentage representing edge devices from the first set wherein the operational metrics deviate from baseline performance values beyond predetermined tolerance thresholds; and determine, after a predefined time duration (Td) from completion of pushing the upgrade, whether to continue with the upgrade rollout to remaining edge devices of the plurality of edge devices.

The system implements progressive deployment through iterative expansion following the arithmetic progression Ni=K+(i−1)(M×K), wherein the processor determines deployment multipliers based on fault percentages, dynamically modifies rollout parameters during execution, maintains deployment logs, generates rollout trajectory predictions, and coordinates rollback procedures when critical thresholds are exceeded. The system accommodates heterogeneous device populations through SKU-specific segregation and maintains separate fault percentage thresholds for different device categories.

According to yet another aspect of the present disclosure, a non-transitory computer-readable storage medium is disclosed, storing instructions that when executed by at least one processor, cause the processor to perform operations for managing an upgrade rollout to a plurality of edge devices. The operations comprise: identifying a first set of edge devices among the plurality of edge devices for an upgrade rollout based on a communication history indicating successful communication frequency between each edge device and a cloud server; pushing the upgrade to the first set of edge devices; receiving feedback from the first set of edge devices comprising information related to operational metrics; determining a fault percentage representing edge devices from the first set wherein the operational metrics deviate from baseline performance values beyond predetermined tolerance thresholds; and determining, after a predefined time duration (Td) from completion of pushing the upgrade, whether to continue with the upgrade rollout to remaining edge devices.

The non-transitory computer-readable storage medium further stores instructions for implementing the iterative deployment mechanism following arithmetic progression, dynamic parameter modification during deployment execution, deployment multiplier determination based on fault percentages, rollback procedure initiation upon exceeding critical thresholds, deployment log maintenance, rollout trajectory prediction generation, and SKU-specific deployment segregation for heterogeneous device populations.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE FIGURES

These and other features, aspects, and advantages of the present invention will become better understood when the following detailed description is read with reference to the accompanying drawings in which like characters represent like parts throughout the drawings, wherein:

FIG. 1 illustrates a schematic block diagram depicting an environment for managing an upgrade in a plurality of edge devices, in accordance with an embodiment of the present disclosure;

FIG. 2 illustrates a schematic block diagram depicting an exemplary system for managing the upgrade in the plurality of edge devices, in accordance with an embodiment of the present disclosure;

FIG. 3 illustrates a schematic block diagram depicting a plurality of modules of the system for managing the upgrade, in accordance with an embodiment of the present disclosure;

FIG. 4 illustrates a flowchart depicting an exemplary method for managing the upgrade in the plurality of edge devices, in accordance with an embodiment of the present disclosure; and

FIG. 5 illustrates an exemplary use case depicting a flow diagram for a software rollout in the plurality of edge devices, in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE FIGURES

For the purpose of promoting an understanding of the principles of the invention, reference will now be made to the various embodiments and specific language will be used to describe the same. It should be understood at the outset that although illustrative implementations of the embodiments of the present disclosure are illustrated below, the present invention may be implemented using any number of techniques, whether currently known or in existence. The present disclosure is not necessarily limited to the illustrative implementations, drawings, and techniques illustrated below, including the exemplary design and implementation illustrated and described herein, but may be modified within the scope of the present disclosure.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Conventional approaches to deploying software upgrades to edge devices typically involve simultaneous distribution to entire device populations or randomly selected subsets. This mass deployment strategy creates significant operational risks when applied to vehicle-mounted edge devices that perform critical monitoring functions. When an upgrade contains unforeseen incompatibilities or performance issues, simultaneous deployment can result in fleet-wide failures affecting hundreds or thousands of vehicles before the problem is detected. The heterogeneous nature of vehicle fleets, with devices operating under varying network conditions, hardware configurations, and environmental factors, makes it impossible to predict how an upgrade will perform across the entire population based on limited testing. Furthermore, the intermittent connectivity characteristic of mobile edge devices means that some devices may receive partial upgrades or experience extended deployment periods, leading to inconsistent fleet states that complicate troubleshooting and recovery efforts.

The present disclosure addresses these challenges through a progressive deployment methodology that systematically expands upgrade distribution based on real-world performance feedback. Rather than deploying to all devices simultaneously, the system initially selects a small subset of edge devices that demonstrate reliable communication patterns with the cloud infrastructure. This first set serves as a controlled test group, providing performance data that informs subsequent deployment decisions. The system monitors operational metrics from upgraded devices, comparing post-upgrade performance against pre-upgrade baselines to detect anomalies or degradations that may indicate compatibility issues or upgrade-induced failures.

The present disclosure provides a feedback-driven expansion mechanism that automatically adjusts deployment velocity based on observed outcomes. When the initial deployment demonstrates successful performance with minimal faults, the system accelerates distribution by increasing the size of subsequent deployment groups according to a calculated multiplier. Conversely, when fault percentages exceed acceptable thresholds, the system reduces deployment pace or terminates the rollout entirely, preventing propagation of problematic upgrades throughout the fleet. This adaptive approach transforms upgrade deployment from a binary all-or-nothing operation into a controlled, iterative process that minimizes risk while maintaining deployment efficiency.

The arithmetic progression model employed by the system provides predictable, manageable expansion of the deployment scope. Each iteration adds a calculated number of devices based on the performance feedback from previous iterations, creating a systematic rollout pattern that can be monitored, adjusted, or reversed as needed. The formula Ni=K+(i−1)(M×K) defines the cumulative deployment size at any iteration, where the multiplier M dynamically adjusts based on real-time fault analysis. This mathematical framework ensures that deployment velocity remains proportional to upgrade stability, automatically throttling distribution when issues emerge and accelerating when confidence increases.

The system's fault detection mechanism employs performance analysis that distinguishes between expected upgrade-related changes and genuine anomalies. By establishing baseline performance metrics before upgrade deployment and accounting for anticipated degradation inherent to the upgrade process, the system accurately identifies edge devices experiencing abnormal behavior. This approach prevents false positives that could unnecessarily slow deployment while ensuring genuine issues trigger appropriate protective responses.

Implementation flexibility enables adaptation to diverse operational requirements across different fleet configurations and deployment scenarios. The predefined time duration between iterations can be adjusted based on geographic distribution, network characteristics, and vehicle operational patterns, ensuring adequate feedback collection before proceeding to subsequent deployment phases. Similarly, fault percentage thresholds and deployment multipliers can be configured to match specific risk tolerance levels and operational priorities, allowing fleet operators to balance deployment speed against safety margins.

The following detailed description presents various embodiments and implementations of the progressive deployment system, illustrating how the feedback-driven expansion mechanism integrates with existing fleet management infrastructures to provide controlled, reliable software distribution across heterogeneous edge device populations.

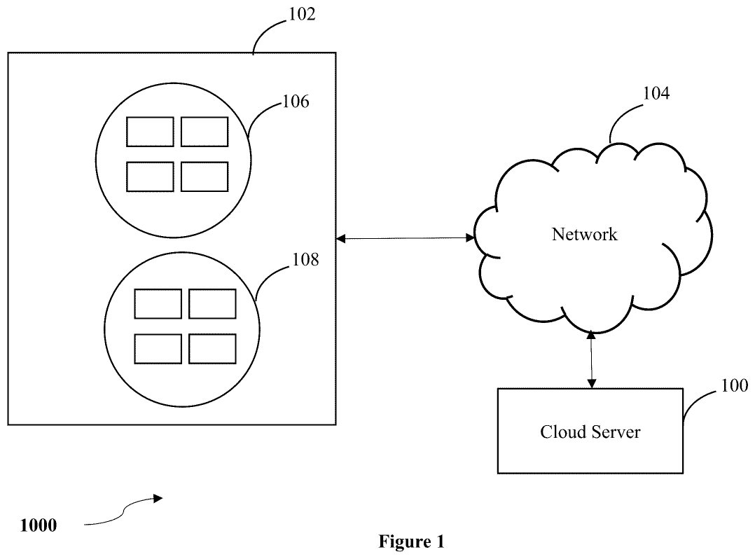

FIG. 1 illustrates an exemplary schematic block diagram depicting an environment 1000 for the implementation of a system 200 for managing an upgrade in a plurality of edge devices 102, in accordance with an embodiment of the present disclosure. In an embodiment, the upgrade for the sake of brevity, may herein refer to software and/or firmware upgrades associated with the plurality of edge devices 102. The upgrade may add new features and/or remove bugs from the plurality of edge devices 102. In another embodiment, the upgrade may be a plurality of upgrades.

In an embodiment, the environment 1000 may include the plurality of edge devices 102 alternatively referred to as the edge devices 102 for the sake of brevity, which may be installed in a vehicle (not shown) in figures. The edge devices 102 may be installed for collecting and computing data locally within the vehicle. In an example embodiment, the data may be received from various components installed in the vehicle such as sensors, or the like. The edge devices 102 may be installed to enable communication between the vehicle and other entities such as vehicle-to-vehicle, vehicle-to-cloud server, and the like. For example, the edge devices 102 may correspond to cameras, radio detection and ranging (RADAR), and light detection and ranging (LIDAR). The edge devices 102 may be configured to provide information to a driver associated with the vehicle via speakers or a display unit. Further, the cameras of the edge devices 102 may be configured to monitor a driving behavior of the driver. In an exemplary scenario, the edge devices 102 may be a larger set of devices selected for a software rollout based on recent communication with a cloud server 100.

The environment 1000 may further include the cloud server 100 that may communicate with the edge devices 102 on a network 104. In an implementation, the network 104 may include a wireless network or a wired network. For example, the network 104 corresponds to cellular networks or mobile networks, such as 3G, 4G, 5G, pre-5G, and 6G networks, or any other wireless communication network such as wireless fidelity (Wi-Fi) connection, near-field communication (NFC) connection, and a Bluetooth connection. In the embodiment, the environment 1000 may include the system 200 (not shown in FIG. 1) which may be implemented at the cloud server 100. In an embodiment, the edge devices 102 may communicate with the cloud server 100 over the network 104 at regular intervals to upload data and receive instructions. In an exemplary embodiment, the cloud server 100 may receive heartbeat signals from the edge devices 102 regularly. In an embodiment, the heartbeat signals may herein refer to regular signals or messages sent by the edge devices 102 to indicate that the edge devices 102 may be connected with the cloud server 100. Further, the heartbeat signals may also indicate that one or more components associated with the edge devices 102 may be in operation. In an embodiment, the one or more components, alternatively referred to as the components for the sake of brevity, of the edge devices 102. For instance, the components of the edge devices 102 may herein refer to hardware and/or software components associated with the edge devices 102. The components may include, for example, CPU, hard disk, battery, processor, and sensors.

In an embodiment, the heartbeat signals may be used to monitor a working status of the hardware and/or software components of each of the edge devices 102 which may be communicating with the cloud server 100. For instance, the working status may be indicative of how the components associated with the edge devices 102 operate. For example, a camera of one of the edge devices 102 is operating without any irregularities.

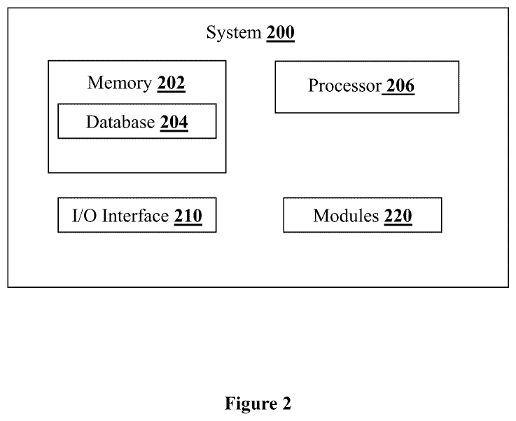

In an embodiment, the system 200 for managing the upgrade may be explained in conjunction with FIG. 2. FIG. 2 illustrates an exemplary block diagram depicting the system 200 for managing the upgrade in the edge devices 102, in accordance with an embodiment of the present disclosure.

In an embodiment, the system 200 may include a memory 202 including a database 204, a processor 206 communicatively coupled with the memory 202, an Input/Output (I/O) interface 210, and a plurality of modules 220. In an embodiment, the system 200 may be implemented at a cloud-based system, that may include the cloud server 100. In another embodiment, the system 200 may be implemented at a user equipment (UE). In a non-limiting example, the UE may be a smartphone, a laptop computer, a desktop computer, a personal computer (PC), a notebook, a tablet, or a smartwatch.

In one embodiment, the memory 202 is configured to store instructions executable by the processor 206. In one embodiment, the memory 202 communicates via a bus within the system 200. The memory 202 includes but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the processor 206. In alternative examples, the memory 202 is separate from the processor 206 such as a cache memory of a processor, the system memory, or other memory. The memory 202 is an external storage device or the memory 202 is for storing data. The memory 202 is operable to store instructions executable by the processor 206. The functions, acts, or tasks illustrated in the figures or described are performed by the programmed processor for executing the instructions stored in the memory 202. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies include multiprocessing, multitasking, parallel processing, and the like.

As a non-limiting example, the processor 206 may be a single processing unit or a set of units each including multiple computing units. The processor 206 may be implemented as one or more microprocessors, microcomputers, microcontrollers, digital signal processors, central processing units, state machines, logic circuitries, and/or any devices that manipulate signals based on operational instructions (computer-readable instructions) stored in the memory 202. Among other capabilities, the processor 206 may be configured to fetch and execute computer-readable instructions and data stored in the memory 202. The processor 206 includes one or a plurality of processors. The plurality of processors is further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors controls the processing of the input data in accordance with a predefined operating rule or an artificial intelligence (AI) model stored in the memory 202. The predefined operating rule or the AI model is provided through training or learning.

The processor 206 may be disposed of in communication with one or more input/output (I/O) devices via the Input/Output (I/O) interface 210. The I/O interface 210 employs communication code-division multiple access (CDMA), high-speed packet access (HSPA+), global system for mobile communications (GSM), long-term evolution (LTE), WiMax, and the like, etc. In another embodiment of the present invention, the I/O interface 210 employs ethernet, industrial wireless Local Area Network (LAN), process field bus (PROFIBUS), actuator sensor (AS) Interface, and the like.

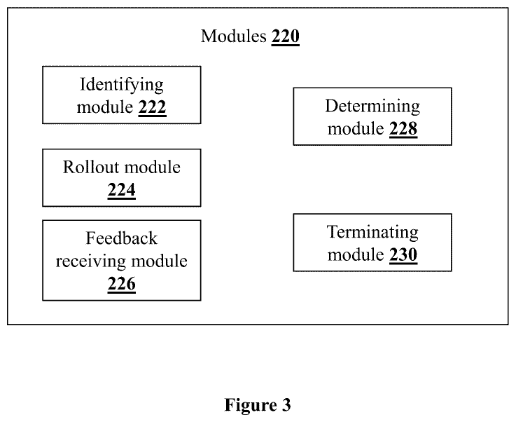

FIG. 3 illustrates a schematic block diagram depicting a plurality of modules 220 of the system 200 for managing the upgrade in the edge devices 102, in accordance with an embodiment of the present disclosure. The plurality of modules 220 may include the one or more instructions (stored in a memory 202) that may be executed to cause the system 200, in particular, the processor 206 of the system 200, to perform the one or more functions/methods, as discussed here in the present disclosure. In one embodiment, the plurality of modules 220 may be implemented at least in part as hardware, which may work in conjunction with the instructions to perform the functions/methods discussed herein.

The plurality of modules 220 may include an identifying module 222, a rollout module 224, a feedback receiving module 226, a determining module 228, and a terminating module 230. In an embodiment, the identifying module 222, the rollout module 224, the feedback-receiving module 226, the determining module 228, and the terminating module 230 may be in communication with each other. In an embodiment, the plurality of modules 220 may be configured to perform various functions for managing the upgrade.

In an embodiment, the identifying module 222 may be configured to identify a first set of edge devices 106 among the plurality of edge devices 102 for an upgrade rollout based on a communication history of the edge devices 102. The communication history comprises multiple connectivity parameters indicating successful communication frequency between each edge device and the cloud server 100, including frequency of heartbeat signals, success rate of data transmissions, temporal recency of communications, and signal strength metrics. The identifying module 222 processes these parameters to generate communication reliability scores for each edge device, wherein edge devices exhibiting scores exceeding predetermined thresholds are selected for inclusion in the first set of edge devices 106. This selection methodology ensures that initial deployment targets devices with demonstrated capability to provide comprehensive feedback during the critical evaluation phase.

The identifying module 222 may further be configured to determine a working status of hardware and software components for each edge device based on telemetry data embedded within the heartbeat signals. In an embodiment, edge devices are selected for the first set when the working status indicates an operating condition without detected irregularities, wherein operating condition comprises stable processor utilization patterns, consistent memory consumption within operational bounds, and absence of critical error indicators. For implementations involving multiple stock keeping units (SKUs), the identifying module 222 maintains SKU-specific selection criteria that account for device-specific performance characteristics and hardware variations, enabling segregated upgrade rollouts tailored to each device category.

The rollout module 224 may be configured to push the upgrade to the first set of edge devices 106 through established over-the-air communication channels. The feedback receiving module 226 may be configured to receive feedback from the first set of edge devices 106, wherein the feedback comprises information related to operational metrics of at least one of software and hardware components. In an embodiment, the operational metrics include processor utilization percentage, memory consumption values, battery discharge rate, component uptime duration, data throughput measurements, and error frequency indicators. The feedback receiving module 226 establishes baseline performance values by monitoring these operational metrics during a pre-upgrade period, calculating average performance values for each metric, and storing said average values as reference baselines for post-upgrade comparison.

The determining module 228 may be configured to determine a fault percentage representing edge devices from the first set wherein the operational metrics deviate from baseline performance values beyond predetermined tolerance thresholds. In an embodiment, the predetermined tolerance thresholds comprise: (i) expected performance degradation values inherent to the upgrade process, representing anticipated resource utilization changes resulting from new features or architectural modifications; and (ii) acceptable deviation ranges determined through pre-deployment testing, defining boundaries of normal operational variance. An edge device is classified as faulty when the cumulative deviation of operational metrics exceeds the sum of expected degradation and acceptable deviation range. For example, if an upgrade introduces features expected to increase processor utilization by 10% with an acceptable deviation of 5%, an edge device exhibiting 20% increased utilization would be flagged as potentially faulty, contributing to the overall fault percentage calculation. The fault percentage represents a conservative detection metric; devices flagged as potentially faulty undergo additional analysis to distinguish between benign operational variations and genuine issues requiring intervention.

The determining module 228 may further be configured to determine, after a predefined time duration (Td) from completion of pushing the upgrade, whether to continue with the upgrade rollout to remaining edge devices of the plurality of edge devices 102. In an embodiment, the predefined time duration is determined based on factors including geographic distribution of edge devices, expected vehicle operational cycles, network traffic patterns, and statistical confidence requirements for feedback collection. The determination to continue or discontinue is based on comparing the calculated fault percentage against critical threshold values, wherein exceeding such thresholds triggers protective mechanisms to prevent propagation of potentially problematic upgrades.

In response to a determination to continue with the upgrade, the determining module 228 may be configured to determine a deployment multiplier (M) based on the fault percentage. The deployment multiplier determination employs a threshold-based classification system wherein: a first multiplier value is assigned when the fault percentage falls below a first threshold, indicating accelerated deployment capability; a second multiplier value is assigned when the fault percentage remains between the first threshold and a second threshold, indicating maintained deployment pace; and wherein the first multiplier value exceeds the second multiplier value. The identifying module 222 may subsequently identify a second set of edge devices 108 from the remaining edge devices, wherein a size of the second set equals the product of the deployment multiplier and the size of the first set, implementing the arithmetic progression Ni=K+(i−1)(M×K).

In an embodiment, the rollout module 224 implements dynamic parameter modification during deployment execution, enabling real-time adjustment of the deployment multiplier between iterations based on emerging performance patterns, modification of the predefined time duration based on feedback collection rates, and adaptation of selection criteria for subsequent device sets based on accumulated deployment data. The rollout module 224 maintains comprehensive deployment logs tracking upgrade status for each edge device, generates rollout trajectory predictions based on current fault percentage trends, and dynamically adjusts the deployment multiplier when actual progress deviates from predicted trajectories beyond confidence bounds.

The terminating module 230 may be configured to terminate further upgrade deployment in response to a determination not to continue with the upgrade rollout, wherein such determination occurs when the fault percentage exceeds a critical threshold value or when a predetermined number of consecutive edge devices report critical component failures. In an embodiment, the terminating module 230 initiates a rollback procedure for the first set of edge devices 106 to restore a previous firmware version, wherein the rollback process preserves device configuration data while reverting executable components to ensure operational continuity. The rollback mechanism may be triggered either immediately upon critical threshold violation or after sustained performance degradation wherein the fault percentage remains above a rollback threshold for a continuous monitoring period exceeding the predefined time duration.

The feedback receiving module 226 implements aggregation mechanisms that collect periodic status reports from each edge device in the first set, aggregate operational metrics across multiple reporting cycles, and identify performance anomalies through statistical deviation analysis. In an embodiment, the aggregation process accommodates varying report frequencies and incomplete data scenarios characteristic of vehicular edge devices with intermittent connectivity, employing interpolation and estimation techniques to maintain analytical continuity. The module correlates temporally distributed metrics to construct comprehensive performance profiles, enabling detection of subtle degradation patterns that may manifest across multiple system components over extended operational periods.

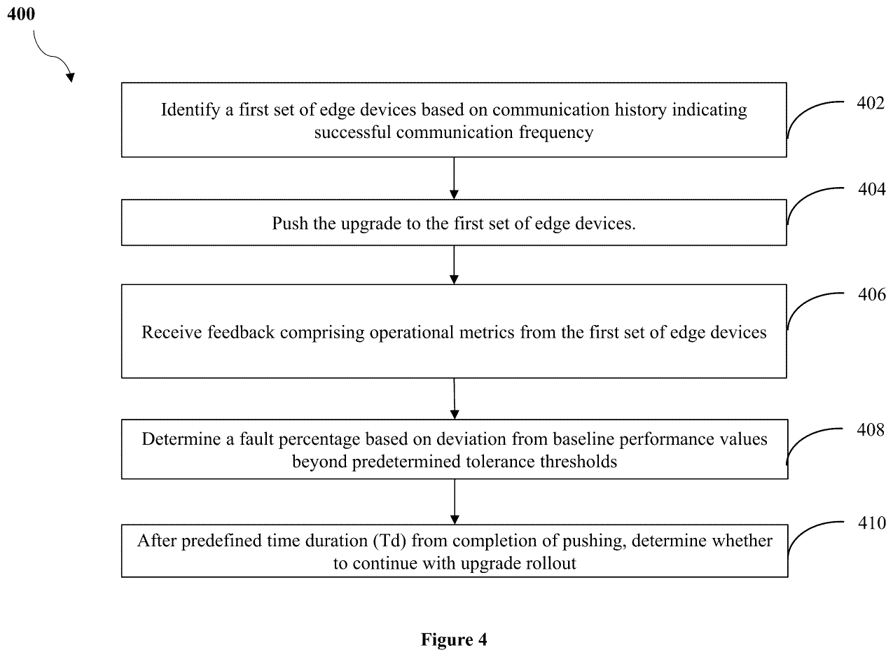

In an embodiment, the present disclosure may be discussed and explained in detail in conjunction with FIG. 4. More specifically, referring to FIGS. 1-4 in combination, the various steps of a method 400 as described hereinafter may be executed in the system 200, or specifically, in the processor 206 of the system 200 which may be implemented at the cloud server 100, for managing the upgrade in the plurality of edge devices 102.

FIG. 4 illustrates a flowchart depicting an exemplary method 400 for managing the upgrade in the plurality of edge devices 102, in accordance with an embodiment of the present disclosure. The method 400 may be a computer-implemented method executed, for example, by the system 200. For the sake of brevity, the constructional and operational features of the system 200 that are already explained in the description of FIG. 1, FIG. 2, and FIG. 3 are not explained in detail in the description of FIG. 4.

Referring to FIG. 4, at step 402, the method 400 may include identifying the first set of edge devices 106 among the plurality of edge devices 102 for the upgrade rollout based on a communication history indicating successful communication frequency between each edge device and the cloud server 100. In an embodiment, the communication history comprises multiple parameters including frequency of heartbeat signals, success rate of data transmissions, temporal recency of last successful communication, and signal strength metrics. The identification process selects edge devices demonstrating reliable connectivity patterns, ensuring robust feedback capability during the evaluation phase.

The communication history analysis evaluates successful communication frequency through quantitative metrics tracked over configurable time windows. In an embodiment, edge devices 102 are ranked based on their communication reliability scores, wherein the first set of edge devices 106 comprises those exhibiting the highest scores. For example, if 10 edge devices out of 100 edge devices demonstrate successful communication rates exceeding 95% with heartbeat transmission frequencies greater than predetermined thresholds within a 24-hour period, these 10 edge devices may be identified as the first set of edge devices 106. The selection ensures that initial deployment targets devices with capability to provide comprehensive operational feedback.

In an embodiment, the method 400 further includes determining a working status of hardware and software components for each edge device based on the heartbeat signals, wherein edge devices are selected for the first set when the working status indicates an operating condition without detected irregularities. The operating condition assessment evaluates whether components function within expected operational parameters, including stable processor utilization, consistent memory consumption patterns, and absence of critical error indicators. This dual-criteria selection combining communication reliability and component health maximizes the probability of successful upgrade deployment and accurate performance assessment.

At step 404, the method 400 may include pushing the upgrade to the first set of edge devices 106 through established over-the-air communication channels. In an exemplary implementation, when the 10 edge devices (first set of edge devices 106) among 100 edge devices (plurality of edge devices 102) demonstrate both high communication frequency and verified operating conditions, the system 200 implemented at the cloud server 100 initiates upgrade transmission to these selected devices. The pushing operation records completion timestamps for each device, establishing temporal reference points for subsequent monitoring phases.

At step 406, the method 400 may include receiving feedback from the first set of edge devices 106, wherein the feedback comprises information related to operational metrics of at least one of software and hardware components. In an embodiment, the operational metrics encompass processor utilization percentage, memory consumption values, battery discharge rate, component uptime duration, data throughput measurements, and error frequency indicators. For example, the feedback may indicate that a device's processor utilization increased from a baseline of 45% to 58% post-upgrade, while memory consumption rose from 2.1 GB to 2.4 GB. The feedback receiving module 226 aggregates these metrics across multiple reporting cycles to construct comprehensive performance profiles.

At step 408, the method 400 may include determining a fault percentage representing edge devices from the first set wherein the operational metrics deviate from baseline performance values beyond predetermined tolerance thresholds. In an embodiment, baseline performance values are generated through pre-upgrade monitoring, capturing average operational metrics under normal conditions. The predetermined tolerance thresholds comprise: (i) expected performance degradation inherent to the upgrade, such as anticipated 10% increase in processor utilization due to new features; and (ii) acceptable deviation ranges determined through pre-deployment testing, such as ±5% variance for normal operational fluctuations. An edge device is classified as “faulty” when cumulative deviation exceeds the sum of expected degradation and acceptable deviation range, even though statistically it would be expected for several properly functioning devices to operate outside of these thresholds for a period of time. For instance, if 3 edge devices out of 10 exhibit battery consumption exceeding baseline by 40% when only 15% degradation was expected with 5% acceptable deviation, these 3 devices contribute to a 30% fault percentage.

At step 410, the method 400 may include determining, after a predefined time duration (Td) from completion of pushing the upgrade, whether to continue with the upgrade rollout to remaining edge devices of the plurality of edge devices. The predefined time duration ensures sufficient data collection for statistically significant fault percentage calculation. In an embodiment, Td is determined based on: geographic distribution of edge devices requiring consideration of time zones and regional network characteristics; expected vehicle operational cycles ensuring feedback capture across typical usage patterns; network traffic patterns affecting data transmission latencies; and statistical confidence intervals for reliable fault assessment. The determination to continue depends on comparing the calculated fault percentage against threshold boundaries that partition the deployment strategy spectrum.

The system 200 determines to continue with the upgrade rollout when the fault percentage falls below threshold values. In an embodiment, the deployment strategy employs multi-tier decision logic where different fault percentage ranges trigger distinct responses. When the fault percentage remains below a first threshold, the system accelerates deployment through increased multiplier values. When the fault percentage falls between first and second thresholds, the system maintains controlled expansion with conservative multipliers.

In response to the determination to continue, the method includes determining a deployment multiplier (M) based on the fault percentage. The multiplier directly influences subsequent deployment velocity by controlling the size of the next edge device set according to the product relationship: size of second set=M×size of first set. This multiplicative expansion implements controlled scaling that responds to upgrade stability.

In a first exemplary embodiment, when the fault percentage is less than a first threshold (e.g., 10%), indicating minimal upgrade-related issues, the multiplier (M) is assigned a higher value such as 2, enabling accelerated deployment. The relationship is expressed as:
Fault percentage<First threshold→M=First multiplier value (accelerated)
In a second exemplary embodiment, when the fault percentage is between the first threshold and a second threshold (e.g., between 10% and 50%), indicating acceptable but non-optimal performance, the multiplier (M) is assigned a lower value such as 1, maintaining conservative deployment pace:
First threshold≤Fault percentage<Second threshold→M=Second multiplier value (maintained)

The deployment multiplier enables adaptive rollout velocity that automatically responds to field conditions. For instance, a fault percentage of 5% triggers M=2, resulting in doubled deployment scope for the next iteration, while a fault percentage of 30% triggers M=1, maintaining consistent deployment size to limit risk exposure.

The method 400 includes identifying a second set of edge devices 108 from the remaining edge devices using the determined multiplier (M). In an embodiment, the size relationship follows:
Size of second set=M×K

Where K represents the size of the first set and M represents the deployment multiplier. This relationship ensures predictable, manageable expansion of deployment scope.

In an exemplary implementation, where the first set comprises 20 edge devices (K=20) and the fault percentage of 8% triggers a multiplier of 2(M=2 ), the second set is determined as 40 edge devices. The identifying module 222 selects these 40 devices from the remaining pool based on their communication history scores, maintaining the same reliability criteria used for initial selection.

The method 400 proceeds with pushing the upgrade to the second set of edge devices 108, initiating the next iteration of the progressive deployment cycle. The iterative process continues with feedback collection, fault percentage calculation, and multiplier determination for each subsequent round.

The method implements arithmetic progression for cumulative deployment tracking, wherein the total number of edge devices receiving the upgrade after iteration i follows:
Ni=K+(i−1)(M×K)
For example, with K=20 and consistent M=2 across iterations:
Iteration 1: N₁=20 devices (first set only)
Iteration 2: N₂=20+40=60 devices total
Iteration 3: N₃=20+80=100 devices total

In embodiments with dynamic multiplier adjustment, each iteration's multiplier responds to the previous iteration's fault percentage. For instance, if iteration 1 with 20 devices yields 5% faults (M=2 for iteration 2), but iteration 2 with 40 additional devices yields 25% faults, the multiplier adjusts to M=1 for iteration 3, deploying only 20 additional devices rather than 40. This adaptive mechanism prevents aggressive expansion when emerging issues are detected.

The system 200 may determine not to continue with the upgrade rollout when the fault percentage exceeds thresholds. In an embodiment, when the fault percentage surpasses a second threshold (e.g., 50%), indicating compatibility issues or performance degradation, the system initiates protective measures to prevent further impact. For example, if 7 edge devices among 10 edge devices (70% fault percentage) exhibit critical performance degradation, the system determines to terminate deployment rather than risk fleet-wide failures.

In response to determining not to continue, the method 400 includes terminating further upgrade deployment to remaining edge devices and initiating rollback procedures for affected devices. The termination decision follows the relationship:
Fault percentage>Critical threshold→Terminate deployment+Initiate rollback

In an exemplary scenario where 20 edge devices (first set) receive the upgrade and subsequent feedback analysis reveals 15 devices (75% fault percentage) experiencing performance degradation beyond acceptable thresholds, the system 200 immediately terminates the rollout. This protective mechanism prevents propagation of problematic upgrades to the remaining 80 devices in the fleet, limiting impact scope while enabling focused remediation.

The method 400 includes initiating a rollback procedure to restore the first set of edge devices 106 to a previous firmware version. In an embodiment, the rollback process preserves device configuration data and operational logs while reverting executable components, ensuring continuity of critical monitoring functions. The terminating module 230 implements synchronized rollback execution, verifying successful restoration through post-rollback operational metric validation.

Through iterative repetition of the identifying, pushing, receiving, and determining steps, the system 200 progressively expands upgrade deployment across the entire edge device population. Each iteration incorporates accumulated learning from previous rounds, with dynamic parameter adjustment enabling responsive adaptation to emerging patterns. The arithmetic progression Ni=K+(i−1)(M×K) provides a framework for deployment planning and progress tracking, where i represents iteration number, K represents initial set size, and M represents the iteration-specific multiplier determined through fault percentage analysis. This systematic approach transforms large-scale upgrade deployment from a high-risk mass distribution into a controlled, observable, and reversible process that minimizes operational disruption while ensuring comprehensive fleet modernization.

In embodiments involving heterogeneous device populations, the method 400 accommodates multiple stock keeping units (SKUs) through segregated rollout management. The system maintains separate fault percentage thresholds for each SKU category, recognizing that different hardware configurations may exhibit varying upgrade compatibility characteristics. For example, newer SKU models with enhanced processing capabilities may tolerate higher resource utilization increases than legacy models, warranting SKU-specific threshold calibration.

The method 400 implements feedback aggregation mechanisms that accommodate the intermittent connectivity characteristic of edge devices. Periodic status reports are collected opportunistically when devices establish network connections, with the feedback receiving module 226 employing statistical interpolation to handle incomplete data sets. Performance anomaly detection utilizes multi-dimensional correlation analysis to identify degradation patterns that may not be apparent in individual metrics but emerge through combined metric evaluation.

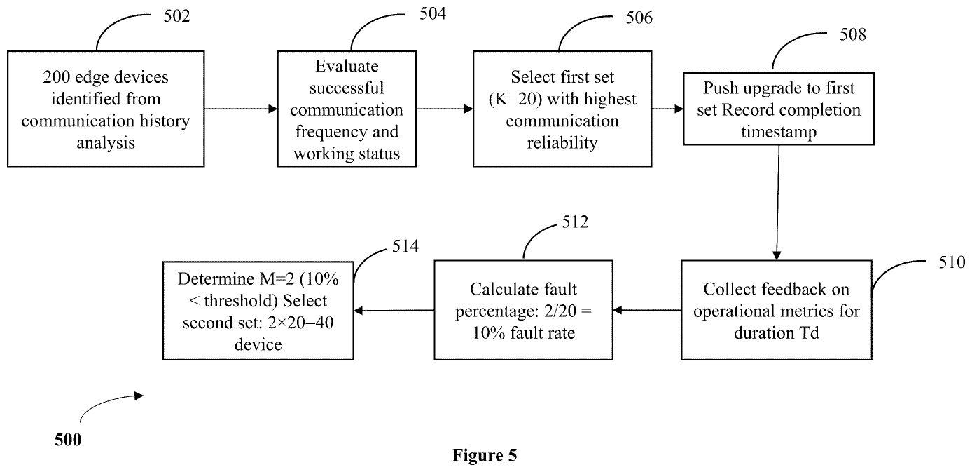

FIG. 5 illustrates an exemplary use case 500 depicting progressive upgrade deployment to the edge devices 102, in accordance with an embodiment of the present disclosure. At block 502, a candidate pool of edge devices 102 is identified for upgrade rollout consideration, wherein 200 edge devices are selected based on their communication history with the cloud server 100. The communication history analysis evaluates successful communication frequency, heartbeat signal patterns, and data transmission reliability to establish a ranked population of deployment candidates.

At block 504, the system 200 evaluates the working status of the identified 200 edge devices through analysis of telemetry data embedded within heartbeat signals. The working status assessment examines hardware component operational states, software process health indicators, and absence of critical error conditions to verify deployment readiness. This dual-criteria evaluation combining communication reliability and component health ensures selection of edge devices capable of providing comprehensive performance feedback during the critical initial deployment phase.

At block 506, the system 200 identifies a first set of edge devices 106 comprising 20 devices that demonstrate the highest communication reliability scores among the candidate population. These 20 edge devices exhibit successful communication frequency exceeding predetermined thresholds, consistent heartbeat transmission patterns, and verified working status indicating operating conditions without detected irregularities. The selection methodology prioritizes devices with demonstrated capability to maintain stable cloud connectivity throughout the upgrade evaluation period.

At block 508, the system 200 pushes the upgrade to the first set of edge devices 106 through established over-the-air communication channels. The upgrade deployment initiates upon confirmation that hardware and software components of these 20 edge devices maintain operating conditions within acceptable parameters. The system 200 records completion timestamps for each device, establishing temporal reference points for the subsequent monitoring phase.

At block 510, the system 200 receives feedback from the first set of edge devices 106 after a predefined time duration (Td) from completion of pushing the upgrade. The feedback comprises operational metrics including processor utilization percentages, memory consumption values, battery discharge rates, and error frequency indicators. The feedback collection period ensures accumulation of statistically significant performance data across varied operational conditions characteristic of vehicular edge device deployment.

At block 512, the system 200 determines a fault percentage through systematic comparison of received operational metrics against baseline performance values. In this exemplary scenario, 2 edge devices among the 20-device first set are classified as faulty based on operational metric deviations exceeding predetermined tolerance thresholds, yielding a fault percentage of 10%. The fault determination accounts for expected performance degradation inherent to the upgrade process while identifying anomalous deviations indicative of compatibility issues or upgrade-induced malfunctions. Further analysis of these flagged devices may reveal benign variations due to environmental conditions rather than actual failures. The conservative detection threshold ensures potential issues are identified early, before any impact to vehicle monitoring capabilities.

At block 514, based on the 10% fault percentage falling below the first threshold for accelerated deployment, the system 200 determines a deployment multiplier M=2 and identifies a second set of edge devices 108 comprising 40 devices. The second set size calculation follows the multiplicative relationship: size of second set=M×K=2×20=40 edge devices, where K represents the first set size. This arithmetic progression-based expansion implements controlled scaling that responds proportionally to observed upgrade stability, doubling deployment scope when fault percentages indicate successful integration.

The system 200 iteratively repeats this progressive deployment process, with each iteration incorporating feedback-driven multiplier adjustments based on cumulative fault percentage analysis. The systematic expansion continues until all 200 edge devices receive the upgrade, with each iteration's deployment velocity automatically adapting to emerging performance patterns. Through this controlled rollout methodology, the system transforms large-scale upgrade distribution from a high-risk simultaneous deployment into a measured, observable, and reversible process that minimizes operational disruption while ensuring comprehensive fleet modernization.

In various embodiments, the present disclosure provides significant technical advantages over conventional upgrade deployment methodologies:
The progressive deployment architecture enables controlled expansion of upgrade distribution through feedback-driven multiplier determination, wherein the system dynamically adjusts deployment velocity based on quantified fault percentages. This adaptive mechanism transforms upgrade rollout from high-risk simultaneous distribution to measured, iterative expansion that automatically throttles deployment when performance degradation exceeds predetermined tolerance thresholds.
The baseline performance comparison methodology establishes quantitative foundations for fault detection through systematic evaluation of operational metric deviations. By differentiating between expected performance degradation inherent to upgrade processes and anomalous deviations indicative of compatibility issues, the system achieves precise fault classification that minimizes false positives while ensuring genuine issues trigger protective responses.
The arithmetic progression model Ni=K+(i−1)(M×K) provides predictable deployment scaling with mathematical certainty, enabling fleet operators to project upgrade completion timelines and resource requirements. This systematic expansion framework facilitates deployment planning, progress monitoring, and risk assessment through clearly defined iteration boundaries and cumulative device tracking.
The communication history-based selection methodology ensures initial deployment targets edge devices with demonstrated capability to provide comprehensive operational feedback. By prioritizing devices exhibiting successful communication frequency above threshold values and verified working status, the system maximizes the reliability of performance assessment during critical evaluation phases, thereby improving subsequent deployment decisions.
The dynamic parameter modification capability enables real-time adaptation to emerging field conditions through adjustment of deployment multipliers between iterations, modification of predefined time durations based on feedback collection rates, and evolution of selection criteria based on accumulated deployment data. This operational flexibility ensures deployment strategies remain responsive to actual performance patterns rather than adhering to static predetermined schedules.
The integrated rollback mechanism provides systematic recovery capabilities when fault percentages exceed critical thresholds, preserving operational continuity through coordinated restoration procedures that maintain device configuration data while reverting executable components. This protective framework limits impact scope when problematic upgrades are detected, preventing fleet-wide propagation of compatibility issues.
The multi-tier threshold system enables efficient deployment strategies through differentiated responses to varying fault percentage ranges, automatically accelerating distribution when minimal issues are detected and constraining expansion when performance degradation approaches acceptable limits.
For heterogeneous device populations, the SKU-specific deployment segregation maintains separate fault percentage thresholds and progression tracking for distinct device categories, accommodating hardware variations and capability differences that influence upgrade compatibility. This differentiated approach prevents slower-performing device categories from constraining overall deployment velocity while ensuring appropriate protective measures for vulnerable device configurations.

The embodiments disclosed herein can be implemented through at least one software program running on at least one hardware device and performing network management functions to control the elements. The elements can be at least one of a hardware device or a combination of hardware devices and software modules.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method for managing an upgrade rollout to a plurality of edge devices, the method comprising:
identifying, by at least one processor of a cloud server, a first set of edge devices among the plurality of edge devices for an upgrade rollout, wherein the identifying is based on a communication history indicating successful communication frequency between each edge device and the cloud server;
pushing the upgrade to the first set of edge devices;
receiving feedback from the first set of edge devices, wherein the feedback comprises information related to operational metrics of at least one of software and hardware components of the first set of edge devices;
determining a fault percentage representing edge devices from the first set wherein the operational metrics deviate from baseline performance values beyond predetermined tolerance thresholds; and
determining, after a predefined time duration (Td) from completion of pushing the upgrade, whether to continue with the upgrade rollout to remaining edge devices of the plurality of edge devices.

2. The method of claim 1, wherein the communication history comprises at least one of:
a frequency of heartbeat signals transmitted from each edge device to the cloud server;
a success rate of data transmissions between each edge device and the cloud server;
a temporal recency of last successful communication with the cloud server; and
a signal strength metric associated with network connectivity.

3. The method of claim 2, wherein identifying the first set of edge devices further comprises: determining a working status of hardware and software components for each edge device based on the heartbeat signals, wherein edge devices are selected for the first set when the working status indicates an operating condition without detected irregularities.

4. The method of claim 1, wherein the operational metrics comprise at least one of:
processor utilization percentage; memory consumption values; battery discharge rate;
component uptime duration; data throughput measurements; and error frequency indicators.

5. The method of claim 4, wherein the baseline performance values are generated by:
monitoring the operational metrics during a pre-upgrade period; calculating average performance values for each metric; and storing said average performance values as reference baselines for post-upgrade comparison.

6. The method of claim 5, wherein the predetermined tolerance thresholds comprise:
expected performance degradation values inherent to the upgrade process; and acceptable deviation ranges determined through pre-deployment testing, wherein an edge device is classified as faulty when operational metric deviation exceeds the sum of expected degradation and acceptable deviation range.

7. The method of claim 1, wherein responsive to determining to continue with the upgrade rollout, the method further comprises: determining a deployment multiplier (M) based on the fault percentage; and identifying a second set of edge devices from the remaining edge devices, wherein a size of the second set equals the product of the deployment multiplier and a size of the first set.

8. The method of claim 7, wherein determining the deployment multiplier comprises:
assigning a first multiplier value when the fault percentage is below a first threshold, indicating accelerated deployment; assigning a second multiplier value when the fault percentage is between the first threshold and a second threshold, indicating maintained deployment pace; and wherein the first multiplier value exceeds the second multiplier value.

9. The method of claim 8, further comprising: iteratively repeating the identifying, pushing, receiving, and determining steps for subsequent sets of edge devices, wherein a cumulative number of edge devices receiving the upgrade in iteration i follows an arithmetic progression defined by: Ni=K+(i−1)(M×K), where K represents the size of the first set, and M represents the deployment multiplier determined for each iteration.

10. The method of claim 9, further comprising: dynamically modifying rollout parameters during deployment execution, wherein the modification comprises adjusting at least one of: the deployment multiplier between iterations based on emerging performance patterns; the predefined time duration based on feedback collection rate; and selection criteria for subsequent device sets based on accumulated deployment data.

11. The method of claim 7, further comprising: maintaining a deployment log tracking upgrade status for each edge device; generating a rollout trajectory prediction based on current fault percentage trends; and dynamically adjusting the deployment multiplier based on the rollout trajectory prediction.

12. The method of claim 1, wherein responsive to determining not to continue with the upgrade rollout, the method further comprises: terminating further upgrade deployment to the remaining edge devices; and initiating a rollback procedure for the first set of edge devices to restore a previous firmware version.

13. The method of claim 11, wherein the determination not to continue occurs when: the fault percentage exceeds a critical threshold value; or a predetermined number of consecutive edge devices report critical component failures.

14. The method of claim 1, wherein the predefined time duration (Td) is determined based on at least one of: geographic distribution of the plurality of edge devices; expected vehicle operational cycles associated with the edge devices; network traffic patterns for the communication infrastructure; and statistical confidence intervals for feedback data collection.

15. The method of claim 1, wherein receiving feedback comprises: collecting periodic status reports from each edge device in the first set; aggregating operational metrics across multiple reporting cycles; and identifying performance anomalies through statistical deviation analysis.

16. The method of claim 1, wherein the plurality of edge devices comprises multiple device models identified by distinct stock keeping units (SKUs), the method further comprising: segregating the upgrade rollout by SKU categories; and maintaining separate fault percentage thresholds for each SKU based on device-specific performance characteristics.

17. A system for managing an upgrade rollout to a plurality of edge devices, the system comprising:
a memory configured to store operational data and deployment parameters; and
at least one processor in communication with the memory, wherein the at least one processor is configured to:
identify a first set of edge devices among the plurality of edge devices for an upgrade rollout, wherein the identifying is based on a communication history indicating successful communication frequency between each edge device and a cloud server;
push the upgrade to the first set of edge devices;
receive feedback from the first set of edge devices, wherein the feedback comprises information related to operational metrics of at least one of software and hardware components of the first set of edge devices;
determine a fault percentage representing edge devices from the first set wherein the operational metrics deviate from baseline performance values beyond predetermined tolerance thresholds; and
determine, after a predefined time duration (Td) from completion of pushing the upgrade, whether to continue with the upgrade rollout to remaining edge devices of the plurality of edge devices.

18. A non-transitory computer-readable storage medium storing instructions that, when executed by at least one processor, cause the at least one processor to perform operations for managing an upgrade rollout to a plurality of edge devices, the operations comprising:
identifying a first set of edge devices among the plurality of edge devices for an upgrade rollout, wherein the identifying is based on a communication history indicating successful communication frequency between each edge device and a cloud server;
pushing the upgrade to the first set of edge devices;
receiving feedback from the first set of edge devices, wherein the feedback comprises information related to operational metrics of at least one of software and hardware components of the first set of edge devices;
determining a fault percentage representing edge devices from the first set wherein the operational metrics deviate from baseline performance values beyond predetermined tolerance thresholds; and
determining, after a predefined time duration (Td) from completion of pushing the upgrade, whether to continue with the upgrade rollout to remaining edge devices of the plurality of edge devices.
